(19) United States
(12) Patent Application Publication
(10) Pub. No.: US 2026/0169826 A1
(43) Pub. Date: Jun. 18, 2026

(54) TAILORING APPLICATION WORKLOAD ACCELERATION

(71) Applicant: Hewlett Packard Enterprise Development LP, Spring, TX (US)

(72) Inventors: Aditya Dhakal, Santa Clarita, CA (US); Kaiwen Cao, Urbana, IL (US); Dejan S. Milojicic, Palo Alto, CA (US)

(21) Appl. No.: 18/984,425

(22) Filed: Dec. 17, 2024

(51) Int. Cl. G06F 9/50

(52) U.S. Cl. CPC G06F 9/5083; G06F 9/5044; G06F 2209/501

(57) ABSTRACT

Accelerator arrangement optimization operations are provided herein. A workload re-distribution system may estimate performance metrics associated with one or more accelerator orchestrations and select, based on the estimated performance metrics, an optimized accelerator arrangement to implement. An application workload may be processed based on the implemented optimized accelerator arrangement. In this manner, the overall efficiency of a computing infrastructure may improve by reducing computing resources spent implementing unoptimized accelerator orchestrations.

### BACKGROUND

The present disclosure relates generally to application implementation efficiencies within a computing infrastructure. More specifically, the present disclosure relates to optimizing implementation of accelerators of a computing infrastructure.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

In the digital world, ever-increasing computer functionalities are available for access and use. With the increase in computer functionalities comes increased production of data and increased speeds of computation. Over time, the computing infrastructures may be specially designed to handle ever-increasing speeds and volumes of data due to scalable architectures and relatively customizable interfaces to fit relatively large ranges of uses. Thus, technology burdens of managing the scalable and customizable computing infrastructures may also continue to increase. For example, a system may have hundreds of accelerators, where one or more accelerators may accelerate different phases of an application.

### DRAWINGS

Features, aspects, and advantages of the present disclosure will become better understood when the following detailed description is read with reference to the accompanying drawings in which like characters represent like parts throughout the drawings, wherein:

FIG. 1 is a diagram, illustrating a workload re-distribution system, in accordance with aspects of the present disclosure;

FIG. 2 is a flowchart, illustrating a process for implementing an accelerator orchestration based upon partitioning an application workload into tasks based on task type and accelerator type, in accordance with aspects of the present disclosure;

FIG. 3 is a diagram, illustrating the workload re-distribution system of FIG. 1 estimating performance metrics and selecting an optimized accelerator orchestration to implement tasks of an application workload, which may be partitioned based on operations of FIG. 2, in accordance with aspects of the present disclosure;

FIG. 4 is a flowchart, illustrating a process for estimating performance metrics and selecting an optimized accelerator orchestration to implement tasks of an application workload, in accordance with aspects of the present disclosure;

FIG. 5 is a flowchart, illustrating a process for estimating performance metrics and selecting an optimized accelerator orchestration to implement tasks of an application workload, which may be partitioned based on operations of FIG. 2, in accordance with aspects of the present disclosure;

FIG. 6 is a flowchart, illustrating a process for re-identifying an optimized accelerator orchestration to implement additional tasks based on a real-time indication of available accelerators and/or current metrics, in accordance with aspects of the present disclosure;

FIG. 7 is a diagram, illustrating a computer-readable medium storing instructions that may cause estimating performance metrics and selecting an optimized accelerator orchestration to implement tasks of an application workload, in accordance with aspects of the present disclosure; and

FIG. 8 is a diagram, illustrating an example computing system associated with the workload re-distribution system of FIG. 1.

### DETAILED DESCRIPTION

One or more specific aspects of the present disclosure will be described below. In an effort to provide a concise description of these aspects, all features of an actual implementation may not be described in the specification. It should be appreciated that in the development of any such actual implementation, as in any engineering or design project, numerous implementation-specific decisions are made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various aspects of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

As computing complexities continue to increase, computing infrastructures may be specially designed to handle ever-increasing speeds and volumes of data due to scalable architectures and relatively customizable interfaces to fit relatively large ranges of uses. Thus, technology burdens of managing the scalable and customizable computing infrastructures may also continue to increase. For example, a system may have hundreds of accelerators, where one or more accelerators may accelerate separate phases of an application.

In some systems, processing systems have traditionally managed application workload processing without considering characteristics of accelerators. Indeed, some systems may perform “blind” evaluations that simply balance distribution of tasks between accelerators without considering a suitability for an accelerator to perform a particular type of task. This may lead to overprovisioning or inefficient use of the accelerators.

Accordingly, the present disclosure relates generally to adapting application workload processing management to include tailored application workload partitioning and accelerator orchestration optimizing. More specifically, the present disclosure relates to adapting accelerator partitioning operations selection and implementation of accelerator orchestration to optimize based on characteristics of accelerators, suitability for respective accelerators to perform respective types of tasks, estimated performance metrics, and the like.

The present disclosure provides a solution that may optimize throughput and reduce latency in computing infrastructures with accelerators. Because many accelerators of many different types may exist within a given computing infrastructure, it may be beneficial to assign tasks or partition application workloads based on the different accelerator types, respective availability of the accelerators and corresponding types of available accelerators, a suitability of a type of accelerator to a type of task, an estimated time to complete processing of the application workload in different accelerator implementations, and the like. Thus, a workload re-distribution system may consider these various factors when partitioning an application workload and/or when identifying or selecting between candidate accelerator orchestrations. In this manner, the overall efficiency of application workload processing may be improved through decreasing the likelihood that computing resources are wasted without being balanced out by another performance tradeoff of the application workload processing. Indeed, by tailoring the evaluation to optimize the balance distribution of tasks between accelerators (e.g., not performing a blind evaluation), a likelihood of strategic computing resource consumption increases. Although the workload re-distribution system may generate a same accelerator orchestration as processing circuitry would in a blind evaluation, the workload re-distribution system does so based on a tailored evaluation that led to an optimized outcome based on real-time statuses, real-time processing demands, and/or real-time constraints, as opposed to doing so based on a blind evaluation that equally balances distribution of tasks between accelerators without concern for suitability.

To elaborate, the workload re-distribution system may profile incoming application data (such as an incoming application workload). The profiling may be used to assign respective profiled tasks to different accelerators based on estimates of processing costs, partitioning possibilities, available accelerators, historical performance data, and the like. The workload re-distribution system may partition application data into relatively smaller portions based on computing tasks to be performed and the specific efficiencies of the accelerators, enabling efficiency improvements to computing infrastructures, like high-performance computing (HPC) systems. Profiling and/or partitioning may enable parts of the application workload to be placed in respective accelerators deemed most optimal at the time of determination. For example, the partitioned application data may be paired with accelerators based on accelerator availability, cost parameters, and the suitability of the computing task to the accelerator. The cost parameters also include transfer costs and any added latencies, which optimizes the data exchange between the application partitions and/or the accelerators such that the added task completion time due to data exchange can be minimized or reduced. This may enable optimizing the data exchange between respective application partitions and accelerators to minimize added task completion time due to latency of data exchange.

Operating a computing infrastructure, like an HPC system, based on the workload re-distribution system, may reduce latency through pairing partitioned application data with a best-fit accelerator of available accelerators to optimize cost parameters. For example, an HPC system implementing optimized accelerator orchestrations may benefit from improved use of computing resources (e.g., minimized idle time of computing resources). The current techniques may, thus, provide HPC application workload implementations that are processed uniformly and cost effectively, providing repeatable efficient performance and increased performance through greater throughput and better use of accelerators relative to other systems. Because some types of accelerators perform different computing functions better or worse than other types, pairing a type of computing task to be performed with a specific accelerator may improve computing efficiency, help optimize downtime between operations, and may improve tailoring distribution of compute tasks to cost parameters.

As application data may be received on an ongoing basis in real-time, the workload re-distribution system may also perform an on-the-fly analysis to adjust best-fit accelerator-to-task pairings with more realistic pairings based on what subset of accelerators are available. In this manner, dynamic task scheduling may occur based on application data partitioning and best-fit analyses. This may enable reevaluation to reoptimize over time as the application workload completion progresses, which may enable re-considering partitioning of the application workload and/or placement of respective application partitions with a particular accelerator and/or accelerator type.

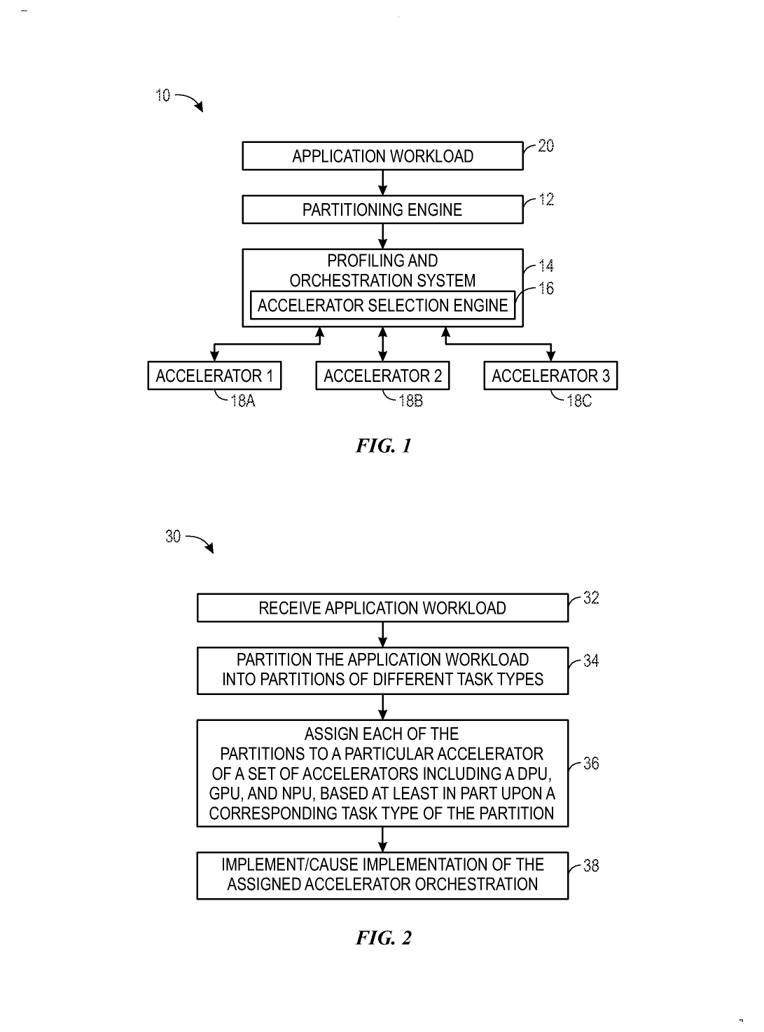

With this in mind, FIG. 1 is a diagram, illustrating a workload re-distribution system 10, in accordance with aspects of the present disclosure. The workload re-distribution system 10 includes a partitioning engine 12, a profiling and orchestration system 14 that includes an accelerator selection engine 16, and accelerators (e.g., accelerator 18A, accelerator 18B, accelerator 18C; collectively referred to as accelerators 18). The workload re-distribution system 10 may implement an accelerator orchestration, generated by the profiling and orchestration system 14, in one or more accelerators 18 and may process an application workload 20 via the implemented accelerator orchestration. The accelerator orchestration may indicate an assignment of an arrangement of one or more available accelerators 18 for processing input and/or output data operations to perform one or more computing tasks relative to one or more assigned partitions of the application workload 20. As such, the accelerator orchestration may indicate an accelerator arrangement to be implemented in one or more accelerators 18 to process one or more partitions of the application workload 20.

The workload re-distribution system 10 may be associated with any suitable type of computing infrastructure configurable to perform distributed processing or parallel processing. For example, such a computing infrastructure may include any suitable computing device, database, data providing entity, components of a “bladed” environment, such as compute blade devices, enclosures or frames, network interconnect devices, disk enclosures, or the like. One such computing infrastructure may include a high-performance computing (HPC) infrastructure. An HPC system may operate based on a computing infrastructure including one or more supercomputing or other higher performance computing devices able to process large sets of data with fast computational speeds, cluster-based computing devices, and the like. When used in the HPC system, the application workload 20 may correspond to a high-performance computing (HPC) application.

One or more devices illustrated in the workload re-distribution system 10 may include any suitable computing devices that may utilize data memory and/or storage, such as servers, desktop computers, laptop computers, tablet computers, cellular devices, wearable devices, and/or other computing devices. The storage/memory may include any suitable articles of manufacture suitable for storing data and/or executable instructions. The storage/memory may include a storage device, such as a Non-Volatile Memory Express (NVMe) device, a hard disk drive (HDD), a solid-state drive (SSD), an optical drive, another type of storage device, flash memory, read-only memory (ROM), or any combination thereof. The storage/memory includes memory that may include any suitable memory devices, such as a double data rate type 5 (DDR5) synchronous dynamic random-access memory (SDRAM), double data rate type 4 (DDR4) SDRAM, low-power double data rate (LPDDR) SDRAM, another suitable type of memory device, or any combination thereof.

The workload re-distribution system 10 may include the accelerators 18 as examples of computing infrastructure configurable to perform or contribute to distributed processing or parallel processing. Indeed, a first one of the accelerators 18 may perform one or more computing operations at an overlapping time duration as one or more additional computing operations performed by a second one of the accelerators 18. For example, the accelerator 18A may perform a portion of a workload at an overlapping time as another portion of the workload is performed by the accelerator 18B and/or the accelerator 18C, and vice versa. Some accelerators 18 may perform operations based on outputs from other accelerators 18. Some accelerators 18 may wait to perform operations until an output is received from another of the accelerators 18. Any suitable computation or processing operation may be performed based on the one or more accelerators 18. Further, although referred herein as accelerators 18, any suitable computing device able to process a portion of an application workload may be used in place of or as an accelerator 18. For example, an accelerator 18 may correspond to a central processing unit (CPU), data processing unit (DPU), a graphics processing unit (GPU), a neural processing unit (NPU), a field programmable gate array (FPGA), a programmable logic device (PLD), or the like, or a combination thereof, such as a DPU that includes an FPGA or PLD, an NPU that includes multiple FPGAs and/or PLDs, or the like.

The partitioning engine 12 may include processing circuitry operable to perform one or more operations, such as partitioning the application workload 20 into one or more tasks, based on executing instructions stored in memory or storage. Each task may correspond to a smaller portion or amount of processing relative to the application workload 20. The partitioning engine 12 may partition the application workload 20 into tasks of non-equal sizes or types. In some systems, processing circuitry may execute instructions stored in memory or storage to provide the partitioning engine 12 and/or perform operations described herein as performed by the partitioning engine 12. For example, such operations may be described herein in reference to operations of FIGS. 2-7.

The profiling and orchestration system 14 may include processing circuitry operable to perform one or more operations, such as profiling each accelerator 18 and identifying candidate accelerator orchestrations. The processing circuitry may execute instructions stored in memory or storage to provide the accelerator selection engine 16 and/or perform operations described herein as performed by the accelerator selection engine 16. For example, such operations may be described herein in reference to operations of FIGS. 2-7.

The partitioning engine 12, the profiling and orchestration system 14, and the one or more accelerators 18 may respectively include input and/or output circuitry through which to receive and/or transmit signals from devices of the computing infrastructure implementing the workload re-distribution system 10. As an example, through first input circuitry, the partitioning engine 12 may receive the application workload 20 for partitioning and through second input the profiling and orchestration system 14 may receive the partitioned application workload 20 from output circuitry of the partitioning engine 12.

The workload re-distribution system 10 may estimate, via the profiling and orchestration system 14, performance metrics associated with one or more accelerator orchestrations. The workload re-distribution system 10 may, via the accelerator selection engine 16, select an optimized accelerator orchestration based on the estimated performance metrics. The profiling and orchestration system 14 may implement the selected optimized accelerator orchestration in one or more of the accelerators 18. The workload re-distribution system 10 may process the application workload 20 based on one or more accelerators 18 being operated according to the implemented optimized accelerator orchestration. In this manner, the overall efficiency of a computing infrastructure may improve by reducing computing resources spent implementing unoptimized accelerator orchestrations. For example, an HPC system implementing optimized accelerator orchestrations may benefit from improved use of computing resources and minimized idle time of computing resources.

The profiling and orchestration system 14 may access a launcher application to profile an accelerator orchestration. The launcher application may be a function-as-a-service (FaaS) provided by processing circuitry executing instructions stored in storage or memory, where the processing circuitry may be included in the profiling and orchestration system 14 or external to the workload re-distribution system 10 and accessible via remote or cloud-based Internet access. As a FaaS, the launcher application may correspond to a cloud-computing service. The launcher application may profile performance of one or more accelerators 18 and the HPC application workload 20. Profiling may indicate a bandwidth between respective accelerators 18, a data arrival pattern expected of the application workload 20, a granularity of the application data of the application workload 20, a size of the application data of the application workload 20, a frequency at which the application data of the application workload 20 is received, operational constraints indicated in memory, a computing capability of each accelerator 18, or the like.

The launcher application may estimate any suitable performance metrics of respective accelerator orchestrations, which may be used to estimate the cost associated with the different accelerator orchestrations to help differentiate between candidate accelerator orchestrations. The launcher application may provide the profiling and orchestration system 14 with metrics by which to decide where, or within which accelerators 18, application partitions are to be placed. Profiling may also reveal processing hotspots and/or processing bottlenecks within the different candidate accelerator orchestrations. For example, the launcher application may estimate an expected time cost, environmental cost, resource cost, or the like. The time cost may include a time expected to be used to transfer partitions of the application workload 20 between accelerators 18. An environmental cost may include a quantification of an amount of energy expected to be used to transfer partitions of the application workload 20 between accelerators 18. A resource cost may include a quantification of the amount of computing resources expected to be used to transfer partitions of the application workload 20 between accelerators 18. The launcher application may determine a time taken for the application workload 20 to run in a target environment, such as a respective accelerator 18 (e.g., a respective CPU, NPU, DPU, or the like). The launcher application may evaluate scaling of backend hardware as a size or quantity of tasks performed as the application workload 20 increases in a respective accelerator orchestration. The launcher application may determine cold-start and/or hot-start latencies associated with implementation in a respective accelerator orchestration. The launcher application may determine a variance between performance predictions and/or input metrics between respective accelerator orchestrations.

As discussed above, the workload re-distribution system 10 may partition the application workload 20 based on operations of the partitioning engine 12. The partitioning engine 12 may partition the application workload 20 based on bandwidth available between respective accelerators 18, application workload 20 data arrival patterns or expected data arrival patterns to occur in the future, or the like. The data arrival patterns may include determining the granularity of application workload 20 data being received and/or a frequency of arrival of the application workload 20 data. In some systems, the partitioning engine 12 may partition the application workload 20 based on design rules and/or computing capabilities of respective accelerators 18, such as limits or preferences of processing, like a maximum permitted bandwidth that may change how large each respective partition is made. These preferences, or other similar preferences used to define partitioning performed, may be accessed by the partitioning engine 12 from memory or received via input circuitry. FIG. 2 illustrates an example of partitioning based on preference indications associating types of tasks with types of accelerators 18. It should be understood that similar operations of FIG. 2 may be applied to additional design parameters, which may indicate one or more bandwidths (e.g., a maximum, minimum, or a range of bandwidth to partition according to), a granularity or a size of the application data (e.g., a maximum, minimum, or a range of granularity to partition according to), operational design preferences, a computing capability of each accelerator of the plurality of accelerators, or the like.

FIG. 2 is a flowchart, illustrating a process 30 for partitioning an application workload into tasks based on task type and accelerator type and implementing the resulting accelerator orchestration, in accordance with aspects of the present disclosure. As mentioned above, the workload re-distribution system 10 may perform the process 30 to partition the application workload (e.g., based on operations of the partitioning engine 12) and to implement the accelerator orchestration (e.g., based on operations of the accelerator selection engine 16). However, other suitable processing circuitry may perform the process 30.

The process 30 begins with receiving an application workload 20, like a high-performance computing (HPC) application (block 32). The workload re-distribution system 10 may receive the application workload 20 at the partitioning engine 12. The application workload 20 may be received over time, such that respective tasks of the application workload 20 are associated with respective task arrival rates. A task arrival rate may be defined relative to arrival timestamps of two or more tasks or portions of the application workload 20. For example, the application workload 20 may correspond to operations of receiving data from a network, parallel processing, aggregating data from the parallel processing, and sending processed data to another computer.

The application workload 20 is partitioned into multiple partitions of different task types (block 34). The partitioning engine 12 may partition the application workload 20 based on grouping tasks into associations, where each partition may be an association of similar tasks. For example, a first partition may associate different tasks or portions of the application workload 20 relative to a second partition of tasks. Examples of task types may include network processing, extraction, deserialization, serialization, machine learning training, coefficient or gradient generation, graphics processing, quantization of sensor data, logical processing, storage media reads, storage media writes, data ingress operations, data egress operations, inference processing, and the like. In some systems, the partitioning may be performed based on task arrival rate. The application workload 20 may correspond to one or more tasks received a threshold time duration from each other. The task arrival rate may be determined relative to two or more tasks through comparing respective arrival times and determining the quantity of tasks arriving over a time period. Application workloads 20 may correspond to one or more tasks and the partitioning engine 12 may associate each task with a respective arrival timestamp based on when the task is received at block 32. One or more tasks received at one or more times may be associated in a partition. The partitioning engine 12 may partition tasks of the application workload 20 based on partitioning rules that indicate what task types are to be grouped together and/or what time period by which to partition over. For example, a first task received at a first time may be grouped with a second task received at a second time when the first task and the second task are to be grouped together (e.g., via partitioning rules defining grouping of tasks) and when the first time is less than a time period threshold from the second time (e.g., via partitioning rules defining time period).

Each of the partitions is assigned to a particular accelerator of a set of accelerators 18 based at least in part upon a corresponding task type of that partition (block 36). Different accelerators 18 may be better suited to perform different types of tasks, and the application workload 20 may be partitioned according to the suitability. For example, the application workload 20 may be partitioned based on a network function task type, a parallel processing function task type, and a neural network computation task type. A DPU may be relatively better suited to implement partitions having the network function task type. A GPU may be relatively better suited to implement partitions having the parallel processing function task type. An NPU may be relatively better suited to implement partitions having the neural network computation task type. As described herein, one or more preference indications may associate respective accelerator types with respective task types. Respective accelerators 18 may be identified by the profiling and orchestration system 14 as more or most suitable for a task type based on profiling operations or historical profiling operations, which may be performed based on the launcher application.

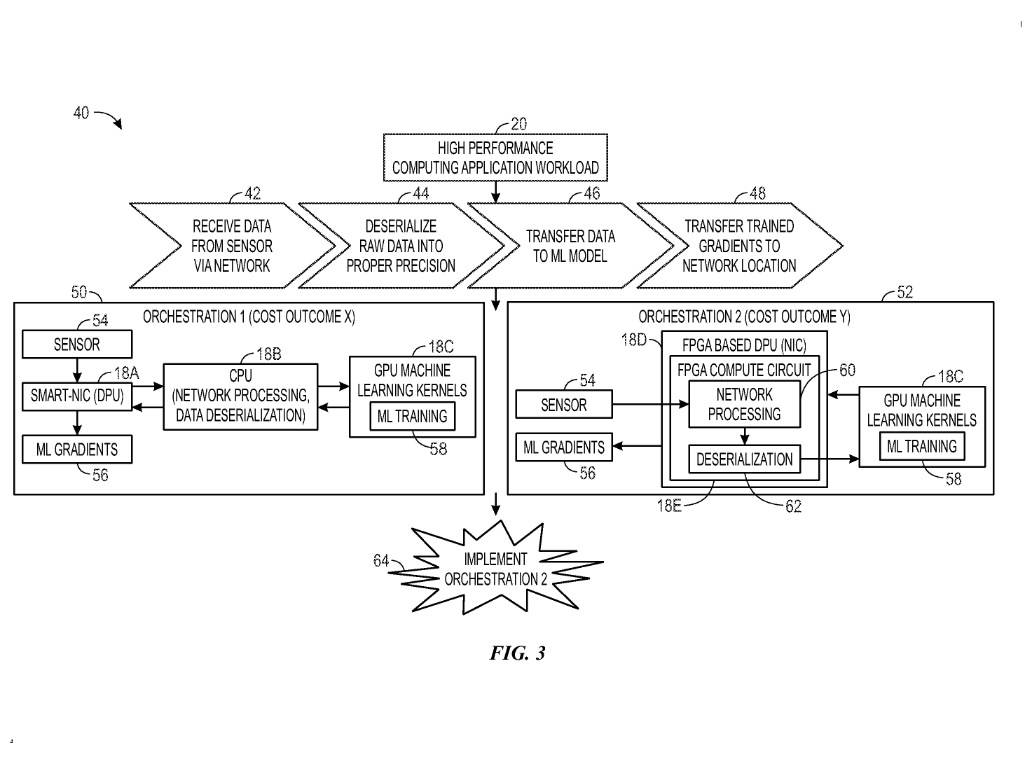

The profiling and orchestration system 14 may receive the partitioned application workload 20 from the partitioning engine 12. The profiling and orchestration system 14 may generate an assigned accelerator orchestration based on the partitioned application workload 20 and a set of accelerators 18. The accelerator orchestration may indicate an arrangement of accelerators 18 or an accelerator orchestration to use when implementing the application workload 20. An accelerator orchestration may associate respective partitions with respective accelerators 18. The accelerator orchestration may correspond to data indicating respective partition and accelerator associations. Although one arrangement is described in process 30, multiple candidate arrangements may be considered and evaluated based on performance metrics, like costs, such as is described herein relative to FIGS. 3-7.

For example, the profiling and orchestration system 14 may identify a first accelerator orchestration based on receiving one or more preference indications and assigning respective accelerators of the set of accelerators 18 to respective partitions of the application workload 20. The preference indication may associate respective accelerator types with respective task types. For example, the profiling and orchestration system 14 may assign, based on the preference indication, respective accelerators 18 of the set of accelerators 18 with the different tasks of the application workload 20, by reading the preference indication. The preference indication may indicate a first association between a deserialization task and a PLD of a DPU. The preference indication may indicate a second association between a machine learning or inference task (e.g., neural network computation task type) and NPUs. The preference indication may indicate a third association between a network data processing task (e.g., network function task type) and DPUs. The preference indication may indicate a fourth association between a network data routing task (e.g., network function task type) and DPUs. The preference indication may indicate a fifth association between a network data parsing task (e.g., network function task type) and DPUs. The preference indication may indicate a sixth association between a data quantization of sensor data task (e.g., network function task type) and DPUs. The preference indication may indicate other associations not described herein.

Based on assignments at block 36, the assigned accelerator orchestration is implemented (block 38). The profiling and orchestration system 14 may implement the assigned accelerator orchestration from block 36 in the set of accelerators 18. The accelerator selection engine 16 may read the assigned accelerator orchestration and operate the profiling and orchestration system 14 to generate one or more instructions, one or more control signals, or the like to cause the assigned accelerator orchestration from block 36 to be implemented in the set of accelerators 18. Once implemented, the application workload 20 may be processed via the implemented assigned accelerator orchestration. Data resulting from the processing may be output from the accelerators 18 and transmitted to storage, transmitted for downstream processing operations, or the like. For example, data generated or processed in one or more accelerators 18 may be transmitted by the accelerators 18 and/or the profiling and orchestration system 14 to cause another computing device external to the computing infrastructure to change its operation, such as to reduce computing resources or power consumption.

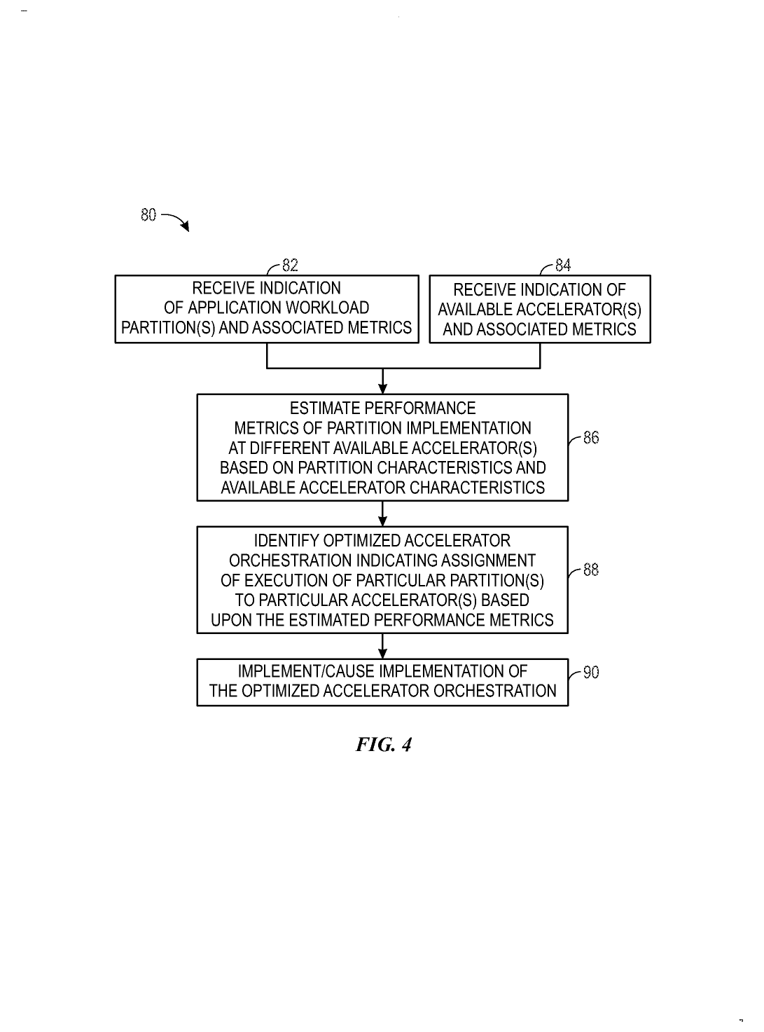

In some systems, the workload re-distribution system 10 may profile the application workload 20 and/or accelerators 18 to determine an optimized accelerator orchestration. Profiling may be used to assign respective profiled tasks to different accelerators based on estimates of processing costs, partitioning possibilities, available accelerators, historical performance data, and the like. The workload re-distribution system 10 may partition application workload 20 data into smaller partitions based on computing tasks to be performed and the specific efficiencies of the accelerators, enabling efficiency improvements to computing systems, like HPC systems. For example, the partitioned application data may be paired with accelerators based on accelerator availability, cost parameters, and the suitability of the computing task to the accelerator. The cost parameters also include transfer costs, and any added latencies associated with the transfer of tasks and associated data between accelerators 18. FIG. 3 elaborates on an example of an HPC application workload and optimizing accelerator orchestration operations and FIG. 4 elaborates on another example of determining an optimized accelerator orchestration based on the application workload 20.

FIG. 3 is a diagram, illustrating the workload re-distribution system 10 estimating performance metrics and selecting an optimized accelerator orchestration to implement tasks of an application workload, which may be partitioned based on operations of FIG. 2, in accordance with aspects of the present disclosure. To implement high-performance computing (HPC), a system may include several types of accelerators 18 to perform tasks on assorted sizes of application workload 20 datasets, such as in machine learning applications. The workload re-distribution system 10 may receive the application workload 20 and redistribute partitions of the application workload 20 to be implemented in different accelerators 18 of the heterogeneous system. Each type of accelerator 18 may have distinctive characteristics, which contribute to different advantages and disadvantages that may arise when applying the several types of accelerators 18 to different types of tasks of application workloads 20. Left unoptimized, costs and latencies may increase from ill-fitted pairings of accelerators to respective tasks to be performed. Thus, to decrease latency and costs, the workload re-distribution system 10 may profile an incoming HPC application workload, as an example of an application workload 20, and determine an accelerator orchestration to implement the HPC application based on estimates of processing costs, partitioning possibilities, available accelerators, historical performance data, and the like.

The workload re-distribution system 10 may receive an HPC application, an example of the application workload 20 described herein. The partitioning engine 12 may partition the HPC application into one or more partitioned tasks, such as partition 42, partition 44, partition 46, partition 48. The profiling and orchestration system 14 may redistribute the partitions 42-48 of the HPC application to be implemented in different accelerators 18. Before identifying a final accelerator orchestration, the profiling and orchestration system 14 may generate indications of candidate accelerator orchestrations and select between the candidates. Here, the candidate accelerator orchestrations include first accelerator orchestration 50 (orchestration 1) and second accelerator orchestration 52 (orchestration 2), which both enable the HPC application to process sensed data from a sensor 54 to train gradient data for storage in a network location based on the partitions 42-48 being implemented in accelerators 18.

Different accelerators 18 may be better suited to perform different types of tasks, and the HPC application may be accordingly partitioned. For example, the HPC application may be partitioned based on a network function task type, a parallel processing function task type, and a neural network computation task type. A DPU may be relatively better suited to implement partitions having the network function task type. A GPU may be relatively better suited to implement partitions having the parallel processing function task type. An NPU may be relatively better suited to implement partitions having the neural network computation task type. As described herein, one or more preference indications may associate respective accelerator types with respective task types.

Indeed, the first accelerator orchestration 50 implements the HPC application in accelerator 18A corresponding to smart network interconnect including a DPU, in accelerator 18B corresponding to a CPU performing network processing and data deserialization tasks, in accelerator 18C corresponding to GPU machine learning kernels and including a machine learning engine 58 executed via the GPU, where outputs (e.g., trained gradient data) are transmitted back through the accelerator 18A and accelerator 18A before being written to network location as machine learning gradient data 56. The first accelerator orchestration 50 may involve data generated by the sensor 54 being transmitted to the NICs in a compute node. The data may be processed via the CPU, which performs the network processing and data deserialization to prepare the data to be used in machine learning training in the GPU. The CPU transmits the data to GPU to perform the machine learning training. While the machine learning training being implemented in the GPU may be desirable, according to preference indications, relatively low utilization of the NIC, as well as data deserialization and network processing being implemented in the CPU, may not be desirable, according to preference indications. The second accelerator orchestration 52 implements the HPC application in accelerator 18D corresponding to a FPGA based DPU operating as a network interconnect (NIC), in accelerator 18E corresponding to the FPGA of the accelerator 18D performing operations based on a network processing engine 60 and deserialization engine 62, and in the accelerator 18C corresponding to GPU machine learning kernels and including the machine learning engine 58 executed via the GPU, where outputs (e.g., trained gradient data) are transmitted back through the accelerator 18D before being written to network location as machine learning gradient data 56. The second accelerator orchestration 52 may involve data generated by the sensor 54 being transmitted to the FPGA of the DPU. The FPGA may perform the deserialization on the data and may transfer the deserialized data to the GPU to implement the machine learning training. The second accelerator orchestration 52 may comport to one or more preference indications, which may enable desirable compute utilization without over-provisioning or under-provisioning of any respective accelerator 18.

The profiling and orchestration system 14 may select and implement an accelerator orchestration from among the candidate accelerator orchestrations. The profiling and orchestration system 14 may select the accelerator orchestration for implementation based on estimated performance metrics arising from profiling each of the candidate accelerator orchestrations. Indeed, to differentiate between the candidate accelerator orchestrations (e.g., first accelerator orchestration 50 and second accelerator orchestration 52), the profiling and orchestration system 14 may profile each of the candidate accelerator orchestrations, as is elaborated on with operations of FIG. 4-7. For example, the profiling and orchestration system 14 may estimate, based on a profile generated by a launcher application, a first cost (cost outcome X) associated with implementing the HPC application workload 20 in a first accelerator orchestration 50. The profiling and orchestration system 14 may estimate a second cost (cost outcome Y) associated with implementing the HPC application workload 20 in a second accelerator orchestration 52. The estimation may be based on a profile generated by the launcher application. The first cost and the second cost may indicate one or more of the following: a time cost, environmental cost, computing resource cost.

Costs, like the first cost or the second cost, may be estimated by the profiling and orchestration system 14 based on task arrival rate, energy costs, latency costs, which may include a cost associated with inter-accelerator delays and costs to transfer data to compute between accelerators 18, and the like. Additional accelerator orchestration candidates may be generated by the profiling and orchestration system 14 that implement different partitioning of sub-components of the HPC application. The profiling and orchestration system 14 may determine a total time expected to process the HPC application for each candidate, which includes for each candidate a respective inter-accelerator 18 transfer latency cost determination, and decide among candidates based on determining which of the total time expectation indications is the lowest. The launcher application may be used by the profiling and orchestration system 14 to profile the HPC application, which may be used in determining the costs. The launcher application may be a software-based framework that measures an estimated cost to execute tasks of the HPC application in different accelerators 18 and that provides a task re-distribution plan as tasks associated with the HPC application arrive. The launcher application may measure the estimated costs based on the bandwidth between the accelerators 18, data arrival pattern based on the granularity of the data associated with the tasks arriving or a frequency of arrival, data processing limits or operational ranges, computing capabilities of respective accelerators 18 (e.g., such as a data processing threshold, like 10 gigabytes (GB) or any suitable threshold, where data above the threshold is to be split into two or more portions), or the like, or any combination thereof.

In this example, the second accelerator orchestration 52 corresponds to a lower cost outcome (e.g., X is greater than Y, X exceeds Y), and thus the profiling and orchestration system 14 determines to implement the second accelerator orchestration 52 as opposed to the first accelerator orchestration 50. The profiling and orchestration system 14 implements the second accelerator orchestration 52, as the selected candidate accelerator orchestration, at operation 64. FIG. 4 illustrates a process that may correspond to the HPC application example of optimizing the accelerator orchestration of FIG. 3, in which partitions of application workloads 20 may be assigned to respective accelerators 18 based on type of accelerator and/or other indicated preferences to optimize according.

FIG. 4 is a flowchart, illustrating a process 80 for estimating performance metrics and selecting an optimized accelerator orchestration to implement tasks of an application workload, in accordance with aspects of the present disclosure. As mentioned above, the workload re-distribution system 10 may perform the process 80 to identify and select between candidate accelerator orchestrations (e.g., based on operations of the profiling and orchestration system 14). However, other suitable processing circuitry may perform the process 80.

The process 80 begins with receiving one or more indications of application workload partitions and associated metrics (block 82). An application workload 20 may be partitioned based on operations of process 30 of FIG. 2 or other suitable operations. Different accelerators 18 may be better suited to perform different types of tasks, and the HPC application may be accordingly partitioned. For example, the HPC application may be partitioned based on a network function task type, a parallel processing function task type, and a neural network computation task type. A DPU may be relatively better suited to implement partitions having the network function task type. A GPU may be relatively better suited to implement partitions having the parallel processing function task type. An NPU may be relatively better suited to implement partitions having the neural network computation task type. As described herein, one or more preference indications may associate respective accelerator types with respective task types.

For example, the application workload 20 may be partitioned by the partitioning engine 12. The partitioning may be based on types of computing task to be used to process data of the application workload 20. The profiling and orchestration system 14 may receive the application workload partitions from the partitioning engine 12. The application workload 20 may be partitioned based on the several types of accelerators 18 used in the computing infrastructure. Indeed, based on receiving a preference indication and an application workload 20, respective accelerators 18 of the accelerators 18 may be assigned to perform different tasks of the application workload 20 based on the preference indication. Sometimes the preference indications and indications of the accelerator 18 types may be used to identify tasks within the application workload 20.

One or more indications of available accelerators 18 and associated metrics are also received (block 84). The profiling and orchestration system 14 may receive an indication of real-time reported statuses of one or more accelerators 18. The statuses may indicate to the profiling and orchestration system 14 which of the accelerators 18 are available at the current time for implementation in an accelerator orchestration. One or more performance metrics may be transmitted with the one or more indications of available accelerators 18. The performance metrics may indicate an expected computing speed of a respective accelerator 18, a permitted bandwidth range associated with communicating with the accelerator 18, or the like.

Performance metrics of partition implementations at different available accelerators 18 are estimated based on application workload partition characteristics and available accelerator characteristics (block 86). Before performance metrics are determined, the profiling and orchestration system 14 may identify two or more candidate accelerator orchestrations based on the preference indication, the application workload partitions, the indications of available accelerators 18, and/or the metrics corresponding to the available accelerators 18. Estimating performance metrics may be based on a profiling of candidate accelerator orchestrations. The profiling and orchestration system 14 may profile an accelerator orchestration. The profiling and orchestration system 14 may profile an accelerator orchestration through pushing, to the launcher application, the accelerator orchestration, and the partitions to be implemented. If one candidate accelerator orchestration was identified, optimization may not be performed. Optimization may be performed to decide between multiple candidate accelerator orchestrations.

To elaborate on determining candidate accelerator optimizations, the profiling and orchestration system 14 may associate respective accelerators 18 and respective partitions based on a type of accelerator 18, a type of computing operation associated with the partition, preference indications of types of each to pair, or the like. Different accelerators 18 may be better suited to perform different types of tasks, and the HPC application may be accordingly partitioned. As described herein, one or more preference indications may associate respective accelerator types with respective task types. The profiling and orchestration system 14 may identify respective accelerator orchestrations as including at least one accelerator 18 different relative to other candidate accelerator orchestrations. Each accelerator 18 may be different between candidate accelerator orchestrations without any overlap between accelerators 18. Some candidate accelerator orchestrations may have overlapping types of accelerators 18. Some candidate accelerator orchestrations may use the same types of accelerators 18 without using the same accelerator hardware (e.g., multiple accelerators 18 each having a same type). The preference indication may indicate a respective accelerator type as a preferred accelerator type to perform the first type of computing task, as described herein relative to FIG. 2 and optimizations may be made relative to inter-accelerator data transfer latencies. The preference indication may associate respective accelerator types with respective computing task, such as to indicate that the accelerator type is more suitable to or assigned to perform that computing task. The suitability of a respective accelerator to perform a respective computing task may correspond to an ability of that accelerator 18 to perform that computing task with relatively low resource consumption or other performance metrics. Indeed, the profiling and orchestration system 14 may receive the preference indication associating the types of accelerators 18 to types of tasks from memory, where the preference indication may have been originally stored in memory during calibration, installation, or the like. Preference indications may be learned overtime by the profiling and orchestration system 14 learning the performance of the computing infrastructure and the accelerators 18 relative to computing tasks performed over time.

In some cases, the profiling and orchestration system 14 may determine a performance metric based on data size of one or more tasks of the application workload 20, a difference in interconnect bandwidth between respective accelerator orchestrations, or both. In some cases, the profiling and orchestration system 14 may determine a performance metric based on determining a first average inter-accelerator task latency in a respective accelerator orchestration, determining a first average intra-accelerator data transfer latency in a respective accelerator orchestration, and combining, as the first performance metric, the first average inter-accelerator task latency and first average intra-accelerator data transfer latency. The profiling and orchestration system 14 may determine a type of accelerator 18 to implement a partition that is also expected to experience less than a maximum task transfer latency. The performance metric may indicate one or more costs of implementation. The costs may include a latency or time cost, environmental cost, and computing resource cost. The data transfer latency may indicate a cost of transferring the data processed by a partition of the application to another partition residing in another accelerator. The data transfer latency may be determined based on a data size of data being transferred between accelerators 18 and an interconnect bandwidth between the accelerators 18.

An optimized accelerator orchestration is identified, where the optimized accelerator orchestration indicates an assignment of execution of application workload partitions to accelerators 18 based on the estimated performance metrics (block 88). The profiling and orchestration system 14 may identify the optimized accelerator orchestration based on the estimated performance metrics of block 86. The profiling and orchestration system 14 may identify the optimized accelerator orchestration based on determining that a candidate accelerator orchestration has the greatest performance metric among the candidate accelerator orchestrations. The profiling and orchestration system 14 may identify the optimized accelerator orchestration based on determining that a candidate accelerator orchestration has the lowest performance metric among the candidate accelerator orchestrations. The profiling and orchestration system 14 may identify the optimized accelerator orchestration based on determining that a candidate accelerator orchestration has a performance metric within a target performance metric threshold range. A combination of these criteria or other similar criteria may be used.

After identifying the optimized accelerator orchestration, the optimized accelerator orchestration is implemented, or implementation is caused (block 90). Once a desired partitioning is identified, the workload re-distribution system 10 may cause, through the profiling and orchestration system 14, implementation of the identified partitioning of the application workload 20 and deploying the respective partitions to one or more accelerators 18 based on the identified partitioning. The accelerator selection engine 16 may generate one or more signals to implement or cause implementation of the selected accelerator orchestration from block 88.

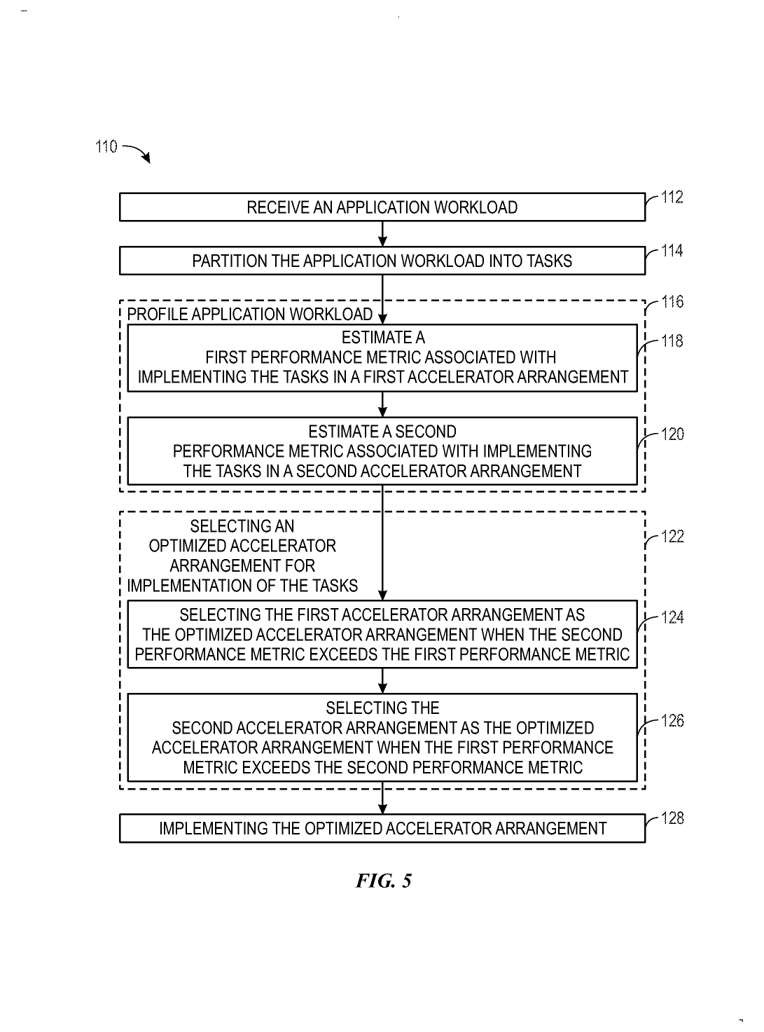

FIG. 5 is a flowchart, illustrating a process 110 for estimating performance metrics and selecting an optimized accelerator orchestration to implement tasks of an application workload 20, where the application workload 20 may be partitioned based on operations of FIG. 2, in accordance with aspects of the present disclosure. As mentioned above, the workload re-distribution system 10 may perform the process 110 to partition the application workload 20 (e.g., based on operations of partitioning engine 12) and to identify and select between candidate accelerator orchestrations (e.g., based on operations of the profiling and orchestration system 14). However, other suitable processing circuitry may perform the process 110. Although described relative to estimating performance metrics of two candidate accelerator orchestrations, more than two candidate accelerator orchestrations may be estimated and evaluated using operations of process 110.

The process 110 begins with receiving an application workload 20 (block 112). An application workload 20 may be partitioned based on operations of process 30 of FIG. 2 or other suitable operations. The workload re-distribution system 10 may receive the application workload 20 at the partitioning engine 12. The application workload 20 may be received over time, such that respective tasks of the application workload 20 are associated with respective task arrival rates. A task arrival rate may be defined relative to arrival timestamps of two or more tasks or portions of the application workload 20.

The application workload 20 is partitioned into one or more tasks (block 114). An application workload 20 may be partitioned based on operations of process 30 of FIG. 2 or other suitable operations. For example, different accelerators 18 may be better suited to perform different types of tasks, and the HPC application may be accordingly partitioned. For example, the HPC application may be partitioned based on a network function task type, a parallel processing function task type, and a neural network computation task type. A DPU may be relatively better suited to implement partitions having the network function task type. A GPU may be relatively better suited to implement partitions having the parallel processing function task type. An NPU may be relatively better suited to implement partitions having the neural network computation task type. As described herein, one or more preference indications may associate respective accelerator types with respective task types.

The partitioning engine 12 may partition the application workload 20 based on grouping tasks into associations, where each partition may be an association of similar tasks. A first partition may associate different tasks or portions of the application workload 20 relative to a second partition of tasks. The partitioning engine 12 may partition tasks of the application workload 20 based on partitioning rules that indicate what task types are to be grouped together and/or what time period by which to partition over.

The application workload 20 is profiled (block 116). This may involve operations of blocks 118 and 120 and may be like operations performed at block 86 of FIG. 4. For example, performance metrics of the application workload 20 may be estimated at different available accelerators based on assigning different partitions to different accelerators. In other words, performance metrics of candidate accelerator orchestrations are determined. Performance metrics may include latency costs of performing the tasks of the partitions via an assigned accelerator 18, latency costs arising from transfer of respective tasks between accelerators 18 according to the candidate accelerator orchestration, a cost in power consumption and/or computing resource consumption to perform tasks in that respective set of accelerators 18 according to that respective combination of partitions, or the like. For example, a first performance metric is estimated associated with implementing the tasks from block 114 in a first accelerator arrangement associated with a first accelerator orchestration (block 118) and a second performance metric is estimated associated with implementing the tasks from block 114 in a second accelerator arrangement associated with a second accelerator orchestration (block 120). Different accelerator arrangements of the candidate accelerator orchestrations may cause different amounts of power, cause different latencies, or the like when the one or more accelerators 18 execute according to the difference accelerator arrangements. These performance characteristics (e.g., power costs, latency costs, or the like) may be identified as performance metrics (e.g., first performance metric, second performance metric) and may be used by the profiling and orchestration system 14 to select between candidate accelerator orchestrations for actual implementation.

Elaborating on these operations (blocks 116-120) , an accelerator arrangement may refer to a relative arrangement of processing operations, data ingress and/or data egress from respective partitions, association between respective partitions and respective accelerators 18 to implement the respective partitions, and/or other specific computing configurations associated with an accelerator orchestration. If one candidate accelerator orchestration was identified, optimization may not be performed. Optimization may be performed to decide between multiple candidate accelerator orchestrations. The profiling and orchestration system 14 may identify two or more candidate accelerator orchestrations based on the preference indication, the application workload partitions, the indications of available accelerators 18, and the metrics corresponding to the available accelerators 18. To determine candidate accelerator optimizations, the profiling and orchestration system 14 may associate respective accelerators 18 and respective partitions based on type of accelerator 18, type of computing operation associated with the partition, preference indications of types of each to pair, or the like. Respective accelerator orchestrations may have one or more different accelerators 18 relative to each other candidate accelerator orchestration. The profiling and orchestration system 14 may re-distribute respective tasks of a plurality of additional tasks among one or more accelerators 18 in the optimized accelerator orchestration. A preference indication may indicate a respective accelerator type as a preferred accelerator type to perform the first type of computing task, as described herein relative to FIG. 2 and optimizations made be made relative to inter-accelerator data transfer latencies. Indeed, the profiling and orchestration system 14 may receive the preference indication from memory. The preference indication may associate respective accelerator types with respective computing tasks. For example, the preference indication may indicate that a first accelerator type is to be used to perform a first computing task, and a second accelerator type is to be used to perform a second computing task. One or more preference indications may indicate a relative ranking among accelerator types more suitable to perform respective computing tasks. The suitability of a respective accelerator to perform a respective computing task may be associated with how that accelerator 18 can perform that computing task with relatively low resource consumption or energy consumption, or other performance metrics.

As noted above, different accelerator orchestrations may correspond to different performance metrics. The different performance metrics may be used by the profiling and orchestration system 14 to identify an accelerator orchestration for implementation. An example of these identification operations are described relative to blocks 122-126.

After profiling one or more candidate accelerator orchestrations, one of the candidates is selected as the optimized accelerator arrangement for implementation of the tasks partitioned at block 114 (block 122). The profiling and orchestration system 14 may select the optimized accelerator arrangement based on the estimated performance metrics at block 116-120 and an instruction to maximize that type of performance metric (e.g., maximization instruction), an instruction to minimize that type of performance metric (e.g., minimization instruction), or another selection criteria. Examples of the estimated performance metrics include latency costs, power costs, computing resource cost, total time to complete, and the like. When the second performance metric exceeds the first performance metric and based on the minimization instruction, the first accelerator orchestration is selected as the optimized accelerator orchestration (block 124). The accelerator selection engine 16 may select the first accelerator orchestration from the two candidate accelerator orchestrations based on the rule instructing minimization when the second accelerator orchestration had the lower performance metric. However, when the first performance metric exceeds the second performance metric and based on the minimization instruction, the second accelerator orchestration is selected as the optimized accelerator orchestration (block 126). The accelerator selection engine 16 may select the second accelerator orchestration from the two candidate accelerator orchestrations based on the rule instructing minimization when the second accelerator orchestration had the lower performance metric. For example, the profiling and orchestration system 14 may receive minimization instruction to minimize a latency and/or an amount of power consumed during processing. Thus, the profiling and orchestration system 14 may select the accelerator orchestration that is able to process the application workload 20 with a lowest amount of power consumed or time taken out of the other accelerator orchestrations being considered.

After selection, the optimized accelerator orchestration is implemented (block 128). The profiling and orchestration system 14 may implement an optimized accelerator orchestration based on partitions of the application workload 20. This may deploy the respective partitions to one or more accelerators 18 based on the identified partitioning and the identified optimized accelerator orchestration. The accelerator selection engine 16 may generate one or more signals to implement or cause implementation of the selected accelerator orchestration from block 88.

Referring back to block 122, the accelerator selection engine 16 may select an accelerator orchestration based on a rule instructing maximization of the performance metric that was estimated. The rule may cause the accelerator selection engine 16 to select the accelerator orchestration with a relatively more efficient performance metric of the estimated performance metrics profiled at block 116. This may lead to selecting the first accelerator orchestration when the corresponding first performance metric exceeds the second performance metric, and vice versa, representing an opposite of operations of blocks 124 and 126 that implement minimization of performance metric. A rule instructing maximization may be used when the estimated performance metrics correspond to execution metrics that may be desired to maximize, such as bandwidth, or processing capabilities, or the like.

As an example, if a maximization instruction been received by the profiling and orchestration system 14, the profiling and orchestration system 14 may select the second accelerator orchestration when the second performance metric exceeds the first performance metric or would select the first accelerator orchestration when the first performance metric exceeds the second performance metric. For example, the profiling and orchestration system 14 may receive a maximization instruction to maximize a volume of data to be processed. Thus, the profiling and orchestration system 14 may select the accelerator orchestration that is able to process a greater volume of data out of the other accelerator orchestrations being considered. a combination of minimization instructions and maximization instructions may be used. Indeed, accelerator selection engine 16 may be operated to select among candidate accelerator orchestrations to maximize bandwidth while minimizing power and latency costs, or any suitable combination of the performance metrics described herein.

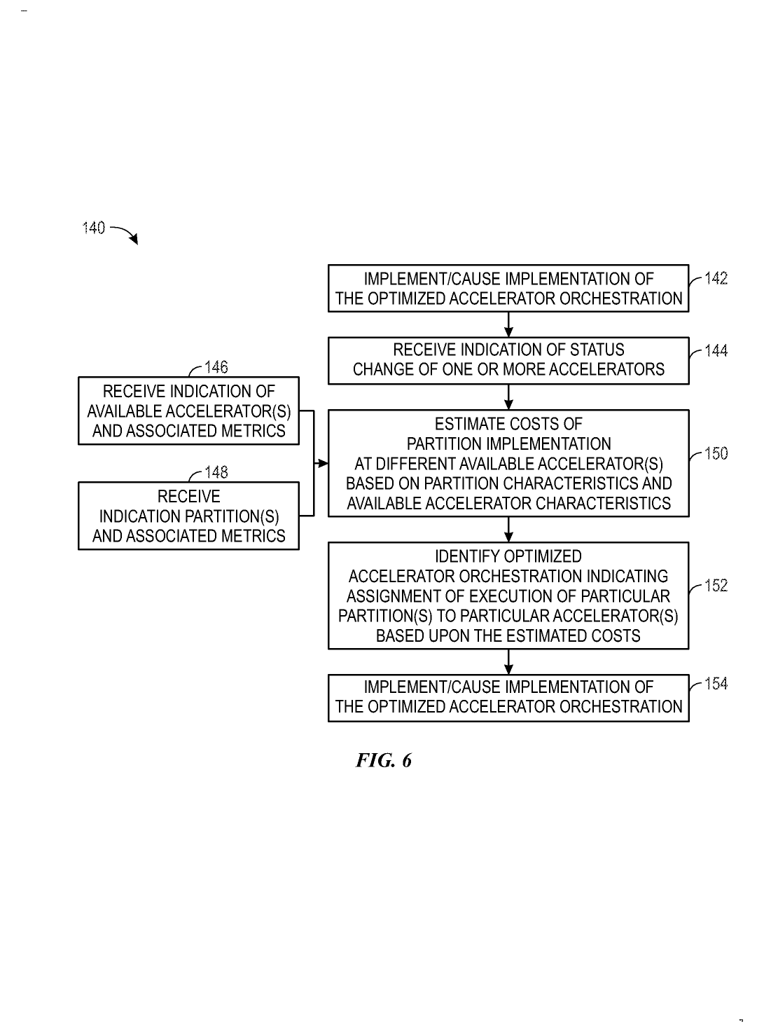

As application data may be received on an ongoing basis in real-time, the workload re-distribution system 10 may also perform an “on-the-fly” analysis to adjust “best-fit” accelerator-to-task pairings with more realistic pairings based on what subset of accelerators are available. Sometimes additional partitions may be received after the application workload 20 is received at block 112. To accommodate status changes and/or additional partitions, dynamic task scheduling may occur based on real-time re-optimizations. Costs may change due to the size of an input (e.g., an influx of a large amount of work may increase processing times of partitions) and/or availability of accelerators 18 (e.g., change in status). For example, in a shared system, a respective accelerator 18 may not always be available and waiting for that accelerator 18 to be free may take time. Thus, the workload re-distribution system 10 may reevaluate how to run a next partition after implementing an optimized accelerator orchestration. Reevaluation may involve at least comparing estimated performance of a new accelerator arrangement and a current accelerator arrangement represented in the implemented optimized accelerator orchestration. Processes illustrated in FIG. 6 may be used to update the optimized accelerator arrangement to accommodate the additional partitions and/or the changes in accelerator 18 status.

FIG. 6 is a flowchart, illustrating a process 140 for re-identifying an optimized accelerator orchestration to implement additional tasks based on a real-time indication of available accelerators and/or current metrics, in accordance with aspects of the present disclosure. As mentioned above, the workload re-distribution system 10 may perform the process 140 to select, implement, and adjust, the accelerator orchestration (e.g., based on operations of the profiling and orchestration system 14). However, other suitable processing circuitry may perform the process 140.

The process 140 begins with the optimized accelerator orchestration being implemented or implementation being caused (block 142). The profiling and orchestration system 14 may implement an optimized accelerator orchestration based on partitions of the application workload 20. This may deploy the respective partitions to one or more accelerators 18 based on the identified partitioning and the identified optimized accelerator orchestration. The accelerator selection engine 16 may generate one or more signals to implement or cause implementation of the selected accelerator orchestration from block 88.

An indication of a status change of one or more accelerators 18 of the implemented optimized accelerator orchestration is received (block 144). After partitioning the application workload 20 and implementing the optimized accelerator arrangement at blocks 114 and 128, changes in computing task or statuses may occur. For example, the status of a respective accelerator 18 may change, such as when an accelerator 18 changes in power state (e.g., powered on, powered off), changes in power supplied (e.g., power removed, power increased), or the like. For example, a look-up table, memory, table data structure, a flag, or the like may report the status change to the profiling and orchestration system 14. The accelerator 18 experiencing the status change may report the status change to the profiling and orchestration system 14.

An indication of available accelerators 18 and associated metrics is received (block 146). One or more accelerators 18 may be available to implement a partition and these accelerators 18 may be reported as being available. For example, a look-up table, memory, table data structure, a flag, or the like may report one or more available statuses and/or some or all of the associated metrics received (block 146) to the profiling and orchestration system 14. Each of the available accelerators 18 may report a status to the profiling and orchestration system 14. In some cases, another computing device may aggregate statuses reported from each of the available accelerators 18 and indicate the aggregated statuses to the profiling and orchestration system 14, including statuses received at block 144. The associated metrics may correspond to estimated performance metrics associated with the one or more available accelerators 18. The profiling and orchestration system 14 may determine the associated metrics and/or external computing devices may determine the associated metrics, such as an embedded application in the external computing device that performs the estimating of the associated metrics (e.g., profiling operations) on behalf of the profiling and orchestration system 14.

An indication of application workload partitions and associated metrics is received (block 148). Sometimes additional partitions may be received after the application workload 20 is received at block 112. For example, the additional partitions may be additional partitions relative to the application workload 20 as an original application workload that was previously received for processing via the computing infrastructure, where the optimized accelerator orchestration implements partitions of the application workload 20.

Performance metrics are estimated of partition implementation of the additional partitions at one or more available accelerators 18 based on the application workload partition characteristics and available accelerator characteristics (block 150). Partitions received at block 148 may be implemented, as part of profiling one or more candidate accelerator orchestrations, in different combinations of the available accelerators 18. Each candidate accelerator orchestration may be profiled to estimate performance metrics expected to occur in an actual implementation of the partitions. The application workload partition characteristics may include a type of computing task associated with the partition. Performance metrics, as described herein, may include estimated latency, estimated power consumption, estimated resource consumption, estimated bandwidth, estimated throughput, or the like. The available accelerator characteristics may include a type of accelerator that is available, such as whether the accelerator available is a CPU, GPU, NPU, DPU, or the like. The performance metrics may be estimated based on pairing computing tasks of the first type to accelerators of a second type, per one or more preference indications. For example, the pairing may occur based on the preference indication indicating a preference to execute parallel processing function task in a GPU type accelerator, neural network computation tasks in a NPU type accelerator, and so on. The profiling and orchestration system 14 may identify two or more candidate accelerator orchestrations based on the preference indication, the application workload partitions, the indications of available accelerators 18, and the metrics corresponding to the available accelerators 18.

Based on the estimated performance metrics, the optimized accelerator orchestration is re-identified, where the re-identified optimized accelerator orchestration indicates assignment of execution of application workload partitions to accelerators 18 (block 152). The profiling and orchestration system 14 may identify the optimized accelerator orchestration based on the estimated performance metrics of block 150. The profiling and orchestration system 14 may identify the optimized accelerator orchestration based on determining that a candidate accelerator orchestration has the greatest performance metric among the candidate accelerator orchestrations. The profiling and orchestration system 14 may identify the optimized accelerator orchestration based on determining that a candidate accelerator orchestration has the lowest performance metric among the candidate accelerator orchestrations. The profiling and orchestration system 14 may identify the optimized accelerator orchestration based on determining that a candidate accelerator orchestration has a performance metric within a target performance metric threshold range. A combination of these criteria or other similar criteria may be used. For example, profiling and orchestration system 14 may select the candidate accelerator orchestration that is expected to consume the lowest amount of power or computing resources, that is expected to process the greatest amount of data, or that balances both from the set of candidate accelerator orchestrations being considered.

The re-identified optimized accelerator orchestration is implemented, or implementation is caused in the accelerators 18 (block 154). The workload re-distribution system 10 may re-distribute respective tasks of a plurality of additional tasks among one or more accelerators 18 in the optimized accelerator orchestration. In some systems, workload re-distribution system 10 implements the change to the optimized accelerator orchestration implemented at block 142 as opposed to re-implementing the entire accelerator orchestration. Once a desired partitioning is identified, the workload re-distribution system 10 may cause, through the profiling and orchestration system 14, implementation of the identified partitioning of the application workload 20 and deploying the respective partitions to one or more accelerators 18 based on the identified partitioning. The accelerator selection engine 16 may generate one or more signals to implement or cause implementation of the selected accelerator orchestration from block 152.

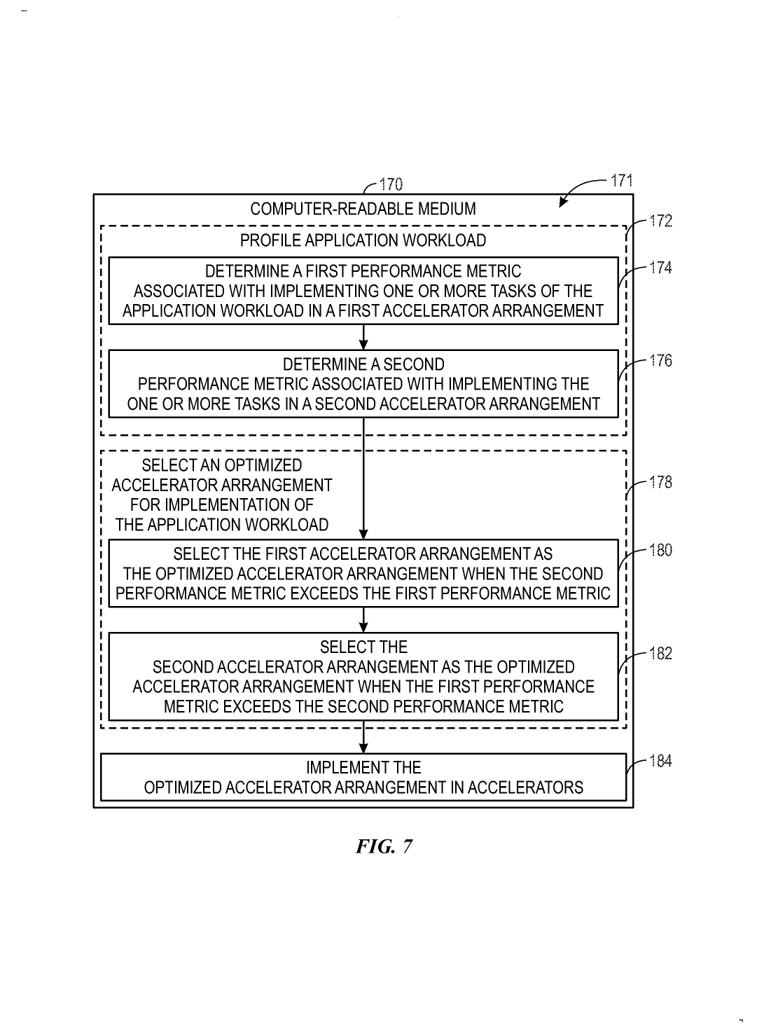

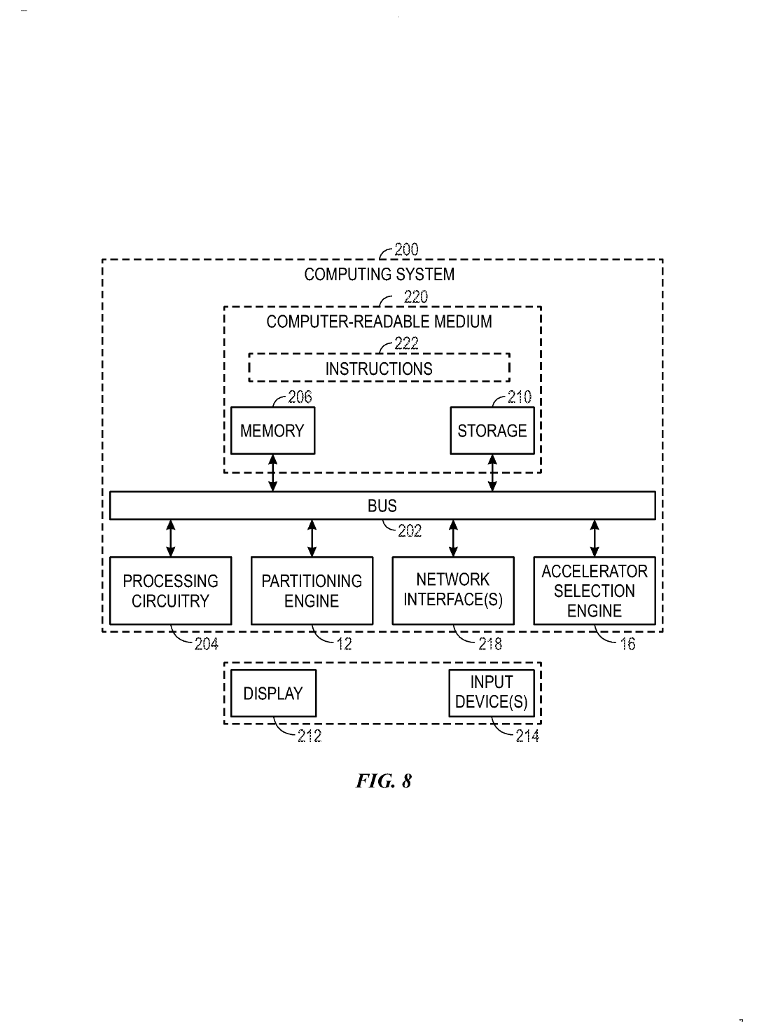

FIG. 7 is a diagram, illustrating a computer-readable medium 170 storing instructions to cause estimating performance metrics and selecting an optimized accelerator orchestration to implement tasks of an application workload 20, in accordance with aspects of the present disclosure. The workload re-distribution system 10 described herein may be any suitable computing device (e.g., computing system 200 of FIG. 8), such as a network device, a WLAN controller, a desktop computer, a laptop computer, a server, a web server, a mainframe, a tablet computer, an e-reader, a netbook computer, a mobile phone, a smartphone, a smart terminal, a dumb terminal, a virtual terminal, and so on. Indeed, the computer-readable medium 170 stores computer-readable instructions that, when executed by one or more processors (e.g., processors of the workload re-distribution system 10) of one or more computers, cause the one or more computers to perform process 171 to cause estimating performance metrics and selecting an optimized accelerator orchestration to implement tasks of an application workload 20.

The one or more computers profile an application workload 20 (block 172). For example, performance metrics of the application workload 20 may be estimated at different available accelerators based on assigning different partitions to different accelerators. Performance metrics may include latency costs of performing the tasks of the partitions via an assigned accelerator, latency costs arising from transfer of respective tasks between accelerators according to the candidate accelerator orchestration, a cost in power consumption and/or computing resource consumption to perform tasks in that respective set of accelerators according to that respective combination of partitions, or the like. This may involve the one or more computers receiving the application workload 20, partitioning the application workload 20 into one or more tasks, where the profiling of the application workload 20 may be based on profiling implementation of respective tasks of the tasks in different candidate accelerators arrangements. Different accelerators 18 may be better suited to perform different types of tasks, and the HPC application accordingly partitioned. As described herein, one or more preference indications may associate respective accelerator types with respective task types. Although two candidate accelerator orchestrations are described relative to FIG. 7, these operations may be applied to more than two candidate accelerator orchestrations. Optimization may be performed to decide between multiple candidate accelerator orchestrations. The one or more computers may identify two or more candidate accelerator orchestrations based on the preference indication, the application workload partitions, the indications of available accelerators 18, and the metrics corresponding to the available accelerators 18. To determine candidate accelerator optimizations, the one or more computers may associate respective accelerators 18 and respective partitions based on type of accelerator 18, type of computing operation associated with the partition, preference indications of types of each to pair, or the like. Respective accelerator orchestrations may have one or more different accelerators 18 and/or different transmission pathways between respective accelerators 18 relative to each other of the candidate accelerator orchestrations. Indeed, different accelerator arrangements (e.g., different candidate accelerator orchestrations) may consume different amounts of power, take different amounts of time to complete, or otherwise may have different performance characteristics arising from executing different respective tasks in the different associated accelerators. These performance characteristics (e.g., power costs, latency costs) may be identified as performance metrics (e.g., first performance metric, second performance metric) and used to select between candidate accelerator orchestrations.

The one or more computers may profile the application workload 20 at block 172 by determining a first performance metric associated with implementing one or more tasks of the application workload 20 in a first accelerator arrangement associated with a first accelerator orchestration (block 174). For example, the first performance metric may indicate an amount of power that the first accelerator orchestration is expected to consume when implementing the one or more tasks of the application workload 20. Tasks may correspond to a partition of the application workload 20. The first accelerator arrangement may refer to a relative arrangement of processing operations, data ingress and/or egress from respective partitions, association between respective partitions and respective accelerators 18 to implement the respective partitions, and/or other specific computing configurations associated with the first accelerator orchestration. The one or more computers may estimate the first performance metric to indicate an expected performance when implementing the one or more tasks in the first accelerator orchestration, as one candidate accelerator orchestration. To determine the first performance metric, the one or more computers may provide the first accelerator orchestration to a launcher framework, where the launcher framework may determine and provide the first performance metric to the one or more computers. The first performance metric may be determined through applying the partitions of the application workload 20 to respective accelerators 18 for implementation, an arrangement of data ingress and data egress (e.g., data paths) between respective accelerators 18, as modified or affected by any other suitable specific computing configurations associated with the first accelerator orchestration, such as bandwidth considerations related to parallel processing ongoing, power operating ranges to respect during processing, or the like.

Similarly, the one or more computers may profile an application workload 20 at block 174 by determining a second performance metric associated with implementing one or more tasks of the application workload 20 in a second accelerator arrangement associated with a second accelerator orchestration (block 176). The tasks may correspond to the partition of the application workload 20 and be the same tasks as the determination in block 174. Like with operations of block 174, the one or more computers may estimate the second performance metric to indicate an expected performance when implementing the one or more tasks in the second accelerator orchestration. For example, the second performance metric may indicate an amount of power that the second accelerator orchestration is expected to consume when implementing the one or more tasks of the application workload 20.

At blocks 174 and 176, the performance metric may be determined by the one or more computers based on estimating the first performance metric and/or the second performance metric as respective costs. The one or more computers may determine the respective costs based on combining (e.g., adding) a first inter-accelerator task latency and a first data transfer latency in the first accelerator orchestration. The one or more computers may determine the respective costs by estimating a data transfer time between respective accelerators 18, by estimating a task arrival rate to respective accelerators 18, by estimating a latency cost in implementing the first accelerator, by estimating an energy cost in implementing the first accelerator orchestration, or the like. The one or more computers may profile the application workload 20 using one or more costs, such as a combination of latency costs and energy costs, or any combination discussed herein.

The one or more computers select an optimized accelerator orchestration for implementation of the application workload 20 (block 178). The one or more computers may select the optimized accelerator arrangement based on the estimated performance metrics and an instruction to maximize that type of performance metric (e.g., maximization instruction), an instruction to minimize that type of performance metric (e.g., minimization instruction), or another selection criteria. Examples of the estimated performance metrics include latency costs, power costs, computing resource cost, total time to complete, and the like.

For example, the one or more computers select, as the optimized accelerator orchestration at block 178, the first accelerator orchestration when the second performance metric exceeds the first performance metric and based on the minimization instruction (block 180). The one or more computers select, as the optimized accelerator orchestration at block 178, the second accelerator orchestration when the first performance metric exceeds the second performance metric and based on the minimization instruction (block 182). The one or more computers may select the optimized accelerator orchestration from two or more candidate accelerator orchestrations based on a rule instructing minimization of the performance metric. The one or more computers may select the optimized accelerator orchestration based on determining which of candidate accelerator orchestration had performance metrics that were the lowest, relative to the other candidate accelerator orchestrations, in combined task latency and data transfer latency, in task arrival rate, in energy cost, or any suitable performance metric described herein. For example, the profiling and orchestration system 14 may receive minimization instruction to minimize a latency and/or an amount of power consumed during processing. Thus, the profiling and orchestration system 14 may select the accelerator orchestration that is able to process the application workload 20 with a lowest amount of power consumed or time taken out of the other accelerator orchestrations being considered.

The one or more computers implement or cause implementation of the optimized accelerator orchestration in one or more accelerators 18 (block 184). The one or more computers may implement an optimized accelerator orchestration based on partitions of the application workload 20. This may deploy the respective partitions to one or more accelerators 18 based on the identified partitioning and the identified optimized accelerator orchestration. The one or more computers may generate one or more signals to implement or cause implementation of the selected accelerator orchestration from block 122.

Referring back to block 172, the one or more computers may select an accelerator orchestration based on a rule instructing maximization of the performance metric that was estimated. The rule may cause the accelerator selection engine 16 to select the accelerator orchestration with the most efficient performance metric of the estimated performance metrics profiled at block 116. This may lead to selecting the first accelerator orchestration when the corresponding first performance metric exceeds the second performance metric, and vice versa, representing an opposite of operations of blocks 124 and 126 that implement minimization of performance metric. A rule instructing maximization may be used when the estimated performance metrics correspond to execution metrics that may be desired to maximize, such as bandwidth, or processing capabilities, or the like.

FIG. 8 is a diagram, illustrating an example computing system 200 associated with the workload re-distribution system of FIG. 1. The computing system 200 may be used as or with systems and/or may implement methods described herein, such as in reference to FIGS. 1-7. The computing device 200 may be or implement, of FIG. 1, the partitioning engine 12, the profiling and orchestration system 14, accelerators 18. Orchestrations described herein may be implemented in one or more devices like the computing device 200.

The workload re-distribution system 10, and thus one or more computing systems 200, may be associated with any suitable type of computing infrastructure configurable to perform distributed processing or parallel processing. One such computing infrastructure may include a high-performance computing (HPC) infrastructure. An HPC system may operate based on a computing infrastructure including one or more supercomputing or other higher performance computing devices able to process large sets of data with fast computational speeds, cluster-based computing devices, and the like. When used in the HPC system, inputs received and/or outputs generated by the computing system 200 may correspond to a high-performance computing (HPC) application.

Examples of the systems and/or devices that may be implemented as the computing system 200 include terminals, network devices, server, web servers, mainframes, tablet computers, desktop computers, laptop computers, mobile phones, smart phones, and the like.

The computing system 200 may include a bus 202. The memory 206 and the storage 210 may be coupled to the bus 202, which enables other components, like the processing circuitry 204, to access the memory 206 and/or the storage 210. The computing system 200 may include additional or alternative communication systems or pathways to enable communication between components of the computing system 200 and/or devices coupled to the computing system 200. The computing system 200 may wirelessly communicate or communicate through wired couplings (e.g., the bus 202) and may include suitable terminals and/or hardware to enable such wireless or wired communication.

The computing system 200 may include processing circuitry 204. The processing circuitry 204 may include one or more accelerators 18, like CPUs, GPUs, NPUs, or the like. The processing circuitry 204 may process information. The processing circuitry 204 may include semiconductor-based microprocessors, field programmable gate arrays (FPGAs), programmable logic devices (PLDs), application specific integrated circuits (ASICs), and/or other hardware devices configurable to retrieve and execute instructions stored and accessible from a computer-readable medium 220. The processing circuitry 204 may correspond to remotely accessed processing resources that the computing system 200 may communicatively couple to through wireless connections, such as in a cloud computing architecture. The processing circuitry 204 may fetch, decode, and execute instructions stored in the computer-readable medium 220 to perform one or more operations, such as operations attributed to being performed by the partitioning engine 12 and/or the accelerator selection engine 16. In this way, the partitioning engine 12 and/or the accelerator selection engine 16 may be firmware embedded or stored within the computing system 200 and executable by the processing circuitry 204.

The computing system 200 may include memory 206 and/or storage 210. The memory 206 and/or the storage 210 may be associated with the computer-readable medium 220. The memory 206 may include random access memory (RAM), cache memory, and/or other volatile memory . The memory 206 may store temporary variables or other intermediate information during the execution of instructions to be executed by the processing circuitry 204. For example, the memory 206 may temporarily store indications of the different orchestration candidates described herein (e.g., at least from FIG. 3). Such instructions, when stored in the memory 206 and/or the storage 210 may cause the processing circuitry 204 to operate the computing system 200 into a special-purpose machine customized to perform the operations specified in the instructions. The computer-readable medium 220 may include static storage (not illustrated), such as non-volatile memory. The storage 210 may include or be non-volatile memory. External storage devices, like a magnetic disk, optical disk, external flash drive, or the like, may be coupled to the computing system 200 to enable the processing circuitry 204 access to additional memory that may be configurable to store information and instructions.

In some cases, the computing system 200 may be coupled to a display 212 via the bus 202. The display 212 may include any suitable display technologies, such as liquid crystal display (LCD) displays, touch sensitive display panels, organic light emitting diode (OLED) displays, or the like. The display 212 may be operated by the processing circuitry 204 to present information to an operator via an image frame rendered via pixels of a display panel of the display 212. For example, the processing circuitry 204 may operate the display 212 to present one or more orchestration candidates to an operator for selection or analysis. An input device 214 may be included. The input device 214 may include keyboard, touch panels, mouse, or other human-machine interfaces that may enable the computing system 200 to receive an input from an operator. Inputs from the input device 214 may be transmitted via the bus 202 to the processing circuitry 204, to the partitioning engine 12, to the accelerator selection engine 16, or the like to facilitate performance of one or more operations described herein.

The computing system 200 may include a network interface 218. The network interface 218 may couple to the bus 202. The network interface 218 may provide a bidirectional communicative coupling to one or more communication network links from the computing system 200. The network interface 218 may enable the processing circuitry 204 to communicate with one or more additional processing circuitry disposed external to the computing system 200 via the communication network links. For example, the network interface 518 may include an integrated services digital network (ISDN) card, a cable modem, a satellite modem, a modem to provide a data communication connection to a telephone line, radio frequency front end and communications circuitry to enable wireless communications, a local area network (LAN) card, or the like.

In some cases, the computer-readable medium 220 stores instructions 222 that, when executed by the processing circuitry 204, may cause the computing system 200 to perform one or more operations described herein relative to at least FIGS. 1-7. The instructions 222 may be stored on any of the memory 206 or storage 210. For example, one or more instructions 222, when executed by the processing circuitry 204, may cause the computing system 200 to implement or cause implementation of an optimized accelerator orchestration. With the foregoing in mind, in some systems, the workload re-distribution system may optimize data paths between storage (or other computing circuitry) and accelerators 18. Storage, like a solid state drive (SSD), may have a capacity of hundreds of terabytes (TB) while a main memory of a CPU may have a capacity of several TB. Meanwhile, an FPGA or GPU may have a device memory with a capacity of relative small when compared to the main memory of the CPU as the device memory may have a capacity of hundreds of GB, which may be less than 1 TB, less than the main memory of the CPU, or the like. Interconnects between different accelerators 18 and/or storage may differ. For example, GPU and FPGA interconnects may have different number of peripheral component interconnect express (PCIe) lanes (e.g., greater number of PCIe lanes) to support a relatively greater connection bandwidth than interconnects that interface with the storage. Indeed, the storage may not have enough PCIe lanes for its associated read or write bandwidth to match or be compatible with higher bandwidths of the FPGA or GPU PCIe bandwidths. To optimize data paths of a respective orchestration example, the workload re-distribution system may consider the data size and interconnect bandwidth differences between each of the storage, FPGA, GPU, and CPU. One example data path of a respective orchestration may stream data from the storage into the CPU for pre-processing operations, and then sending processed data from the CPU to the GPU for further processing operations. Another example data path of the respective orchestration may stream data from storage to FPGA for pre-processing operations and send to the GPU for the same further processing operations. The workload re-distribution system may analyze and select between example data paths to implement in the respective orchestration based on performance of each accelerator 18 using data of different sizes since there may be tradeoffs between transfer latencies and processing latencies associated with the different example implementations.

Systems and methods described herein enable a workload re-distribution system to optimize an accelerator orchestration. The workload re-distribution system may estimate one or more performance metrics, such as costs, associated with one or more accelerator orchestrations and select, based on the estimated performance metrics, an optimized accelerator orchestration to implement. Selecting the accelerator orchestration to implement may be based on a minimization of costs or a maximization of throughput or bandwidth, or any suitable metric or combination of metrics. Selecting the accelerator orchestration to implement may be based on pairing a type of accelerator to a type of task used to process a portion of the application workload. Different accelerators may be better suited to perform different types of tasks, and the application workload accordingly partitioned. For example, the application workload may be partitioned based on a network function task type, a parallel processing function task type, and a neural network computation task type. A DPU may be relatively better suited to implement partitions having the network function task type. A GPU may be relatively better suited to implement partitions having the parallel processing function task type. An NPU may be relatively better suited to implement partitions having the neural network computation task type. One or more preference indications may associate respective accelerator types with respective task types. As an example, a high-performance computing (HPC) system may implement the optimized accelerator orchestration in one or more accelerators designed based on the one or more preference indications. The HPC system may process an application workload in the implemented optimized accelerator orchestration. In this manner, the overall efficiency of the HPC system may improve by reducing computing resources spent implementing unoptimized accelerator orchestrations. Over time, at runtime, the workload re-distribution system may re-evaluate application progress and dynamically adjust partitioning, distribution, and/or data paths if a lower cost or lower latency arrangement of accelerators is identified. This may be performed on a regular, or periodic basis, or in response to a new task arriving.

While certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A computer-implemented method, comprising:
receiving an application workload;
partitioning the application workload into a plurality of tasks;
estimating a first performance metric associated with implementing the plurality of tasks in a first accelerator arrangement;
estimating a second performance metric associated with implementing the plurality of tasks in a second accelerator arrangement; and
selecting an optimized accelerator arrangement for implementation of the plurality of tasks, by:
selecting the first accelerator arrangement as the optimized accelerator arrangement when the second performance metric exceeds the first performance metric; and
selecting the second accelerator arrangement as the optimized accelerator arrangement when the first performance metric exceeds the second performance metric; and
implementing the optimized accelerator arrangement.

2. The computer-implemented method of claim 1, wherein:
estimating the first performance metric comprises combining, as a first cost, a first inter-accelerator task latency and a first data transfer latency in the first accelerator arrangement; and
estimating the second performance metric comprises combining, as a second cost, a second inter-accelerator task latency and a second data transfer latency in the second accelerator arrangement.

3. The computer-implemented method of claim 2, wherein estimating the first performance metric comprises:
estimating, as the first inter-accelerator task latency, a first latency cost of implementing a first task in a first accelerator of the first accelerator arrangement;
estimating, as the first data transfer latency, a second latency cost of transferring a result from the first accelerator to a second accelerator of the first accelerator arrangement; and
determining, based on adding the first latency cost and the second latency cost, the first cost as the first performance metric.

4. The computer-implemented method of claim 1, comprising:
receiving an additional task;
estimating a third performance metric associated with implementing the additional task in the optimized accelerator arrangement;
estimating a fourth performance metric associated with implementing the additional task in a third accelerator arrangement; and
selecting a re-distributed accelerator arrangement to include the additional task, by:
selecting the optimized accelerator arrangement as the re-distributed accelerator arrangement when the fourth performance metric exceeds the third performance metric; and
selecting the third accelerator arrangement as the re-distributed accelerator arrangement when the third performance metric exceeds the fourth performance metric.

5. The computer-implemented method of claim 4, comprising identifying the third accelerator arrangement based on adjusting distribution of tasks and data paths between one or more respective accelerators in the optimized accelerator arrangement.

6. The computer-implemented method of claim 1, wherein partitioning the application workload into the plurality of tasks comprises:
partitioning the application workload into the plurality of tasks based on types of tasks to be performed.

7. The computer-implemented method of claim 6, comprising identifying the first accelerator arrangement, by:
receiving a preference indication, the preference indication associating the types of tasks to be performed to respective types of accelerators of a plurality of accelerators;
receiving the plurality of tasks; and
assigning, based on the preference indication, one or more accelerators as the first accelerator arrangement of the plurality of accelerators to different tasks of the plurality of tasks.

8. The computer-implemented method of claim 1, wherein estimating the first performance metric comprises:
estimating a data transfer time between respective accelerators in the first accelerator arrangement;
estimating a task arrival rate to respective accelerators in the first accelerator arrangement;
estimating a latency cost in implementing the first accelerator arrangement; or
estimating an energy cost in implementing the first accelerator arrangement;
or any combination thereof.

9. A workload re-distribution system, comprising:
a plurality of accelerators; and
processing circuitry configured to:
receive a first performance metric associated with a first accelerator arrangement of the plurality of accelerators;
receive a second performance metric associated with a second accelerator arrangement of the plurality of accelerators;
select an optimized accelerator arrangement for implementation of a plurality of tasks, by:
selecting the first accelerator arrangement as the optimized accelerator arrangement when the second performance metric exceeds the first performance metric; and
selecting the second accelerator arrangement as the optimized accelerator arrangement when the first performance metric exceeds the second performance metric; and
implement the optimized accelerator arrangement.

10. The workload re-distribution system of claim 9, wherein the plurality of accelerators comprises a central processing unit, a graphics processing unit, a neural processing unit, a data processing unit, or any combination thereof.

11. The workload re-distribution system of claim 9, wherein the processing circuitry is configured to identify the first accelerator arrangement, by:
receiving a preference indication;
receiving an application workload; and
assigning, based on the preference indication, respective accelerators of the plurality of accelerators with different tasks of the application workload.

12. The workload re-distribution system of claim 9, wherein the processing circuitry is configured to identify the first accelerator arrangement, the first accelerator arrangement including at least one different accelerator relative to the second accelerator arrangement.

13. The workload re-distribution system of claim 9, wherein the processing circuitry is configured to re-distribute respective tasks of a plurality of additional tasks among one or more accelerators in the optimized accelerator arrangement.

14. The workload re-distribution system of claim 9, wherein the processing circuitry is configured to:
receive an additional task;
estimate a third performance metric associated with implementing the additional task in the optimized accelerator arrangement;
estimate a fourth performance metric associated with implementing the additional task in a third accelerator arrangement; and
select a re-distributed accelerator arrangement to include the additional task, by:
selecting the optimized accelerator arrangement as the re-distributed accelerator arrangement when the fourth performance metric exceeds the third performance metric; and
selecting the third accelerator arrangement as the re-distributed accelerator arrangement when the third performance metric exceeds the fourth performance metric; and
implement the re-distributed accelerator arrangement relative to the additional task.

15. A non-transitory, computer-readable medium, comprising computer-readable instructions that, when executed by one or more processors of one or more computers, cause the one or more computers to:
profile an application workload, by:
determining a first performance metric associated with implementing one or more tasks of the application workload in a first accelerator arrangement; and
determining a second performance metric associated with implementing the one or more tasks in a second accelerator arrangement;
select an optimized accelerator arrangement for implementation of the application workload, by:
selecting the first accelerator arrangement as the optimized accelerator arrangement when the second performance metric exceeds the first performance metric; and
selecting the second accelerator arrangement as the optimized accelerator arrangement when the first performance metric exceeds the second performance metric; and
implement the optimized accelerator arrangement in a plurality of accelerators.

16. The non-transitory, computer-readable medium of claim 15, comprising computer-readable instructions that, when executed by the one or more processors of the one or more computers, cause the one or more computers to:
identify the first accelerator arrangement, by:
receiving a preference indication;
receiving the application workload; and
assigning, based on the preference indication, respective accelerators of the plurality of accelerators with different tasks of the application workload.

17. The non-transitory, computer-readable medium of claim 15, comprising computer-readable instructions that, when executed by the one or more processors of the one or more computers, cause the one or more computers to determine the first performance metric based on data size of the one or more tasks of the application workload, a difference in interconnect bandwidth of the first accelerator arrangement, or both.

18. The non-transitory, computer-readable medium of claim 15, comprising computer-readable instructions that, when executed by the one or more processors of the one or more computers, cause the one or more computers to determine the first performance metric, by:
determining a first average inter-accelerator task latency in the first accelerator arrangement;
determining a first average intra-accelerator data transfer latency in the first accelerator arrangement; and
combining, as the first performance metric, the first average inter-accelerator task latency and first average intra-accelerator data transfer latency.

19. The non-transitory, computer-readable medium of claim 15, comprising computer-readable instructions that, when executed by the one or more processors of the one or more computers, cause the one or more computers to:
partition the application workload into the one or more tasks, by:
receiving the application workload;
receiving a precision indication; and
deserializing, based on the precision indication, the application workload into the one or more tasks.

20. The non-transitory, computer-readable medium of claim 15, comprising computer-readable instructions that, when executed by the one or more processors of the one or more computers, cause the one or more computers to:
after implementing at least one task of the application workload in the optimized accelerator arrangement, receive a status change of an accelerator in the optimized accelerator arrangement;
estimate a third performance metric associated with implementing one or more remaining tasks of the application workload in the optimized accelerator arrangement;
estimate a fourth performance metric associated with implementing the one or more remaining tasks in a third accelerator arrangement, the third accelerator arrangement excluding the accelerator; and
select a re-distributed accelerator arrangement, by:
selecting the optimized accelerator arrangement as the re-distributed accelerator arrangement when the fourth performance metric exceeds the third performance metric; and
selecting the third accelerator arrangement as the re-distributed accelerator arrangement when the third performance metric exceeds the fourth performance metric; and
implement the re-distributed accelerator arrangement relative to the one or more remaining tasks.
